(19) United States
(12) Patent Application Publication
(10) Pub. No.: US 2008/0279292 A1
(43) Pub. Date: Nov. 13, 2008

(54) WIRELESS COMMUNICATION APPARATUS AND METHOD

(76) Inventors: Yasuhiko TANABE, Kawasaki-shi (JP); Yoshimasa Egashira, Yokohama-shi (JP); Kazumi Sato, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/052,012

(22) Filed: Mar. 20, 2008

(30) Foreign Application Priority Data
May 8, 2007 (JP) 2007-123641

(51) Int. Cl. H04L 27/28

(52) U.S. Cl. 375/260

(57) ABSTRACT

The wireless transmission apparatus generates one or a plurality of Orthogonal Frequency Division Multiplexing (OFDM) symbols for channel estimation, each OFDM symbol including plural subcarriers and having a known signal sequence of known signals which are linearly independent between adjacent subcarriers, and transmits the OFDM symbols.

### CROSS-REFERENCE TO RELATED APPLICATIONS

This application is based upon and claims the benefit of priority from prior Japanese Patent Application No. 2007-123641, filed May 8, 2007, the entire contents of which are incorporated herein by reference.

### BACKGROUND OF THE INVENTION

1. Field of the Invention

The present invention relates to a wireless communication system using an OFDM transmission scheme.

2. Description of the Related Art

With an increase in frequency bandwidth used for communication to speed up wireless communication, it is impossible to neglect the propagation delay time differences between multipath propagation paths. In an environment in which signals with different propagation delay times arrive, waveform distortion due to intersymbol interference is a large factor causing a deterioration in communication quality. An orthogonal frequency division multiplexing (OFDM) scheme is known as a scheme which can easily compensate for waveform distortion due to intersymbol interference even if signals with different propagation delay times are received.

According to the OFDM transmission scheme, a channel response is estimated for each subcarrier by transmitting a known signal for channel estimation, and demodulation or equalization processing is performed for each subcarrier by using the estimated channel response. As such a known signal for channel estimation, a known signal robust against noise, channel variations, and multipath propagation path distortion has been used (see, for example, references 1, 2, and 3).

A transmitter used in a wireless transmission apparatus or wireless reception apparatus generally includes phase noise. Offsets generally occur in the frequencies of sine waves generated by the transmission apparatus and the reception apparatus. In OFDM transmission, interference occurs from adjacent subcarriers due to the influences of such phase noise and frequency offsets. In addition, in OFDM transmission, interference occurs between subcarriers symmetrical to each other with respect to the center frequency due to amplitude and phase errors in an quadrature modulator used in the wireless transmission apparatus, individual differences between two digital-to-analog converters and filters used when in-phase and quadrature components are converted into analog signals, amplitude and phase errors in an quadrature demodulator used in the wireless reception apparatus, individual differences between analog-to-digital converters, individual differences between filters, and the like.

If interference occurs between subcarriers due to the imperfection of the analog circuit in this manner, the transmission performance is greatly limited by an interference signal. Known signals for channel estimation which have been proposed have not been designed to prevent such interference.

As described above, conventional known signals for channel estimation are not designed to provide robustness against interference caused between subcarriers by distortion in the analog circuit. For this reason, a channel estimation result contains inter-subcarrier interference, and it is impossible to prevent a deterioration in reception performance. It is necessary to apply complicated interference removal processing to the wireless reception apparatus to prevent inter-subcarrier interference. This poses problems associated with increases in circuit size, processing delay, and power consumption.

Reference 1: Digital Broadcasting Systems for Television, Sound and Data Services; Framing Structure, Channel Coding and Modulation for Digital Terrestrial Television, Europian Telecommunication Standards (ETS) 300 744, 1997

Reference 2: Wireless LAN Medium Access Control (MAC) and Physical Layer (PHY) specifications: High-speed Physical Layer in the 5-GHz Band, IEEE Std 802.11a-1999, 2000

Reference 3: S. Coffey, A. Kasher, and A. Stephens, Joint Proposal: High throughput extension to the 802.11 Standard: PHY, IEEE802.11-05/1102r04, January 2006

### BRIEF SUMMARY OF THE INVENTION

The wireless transmission apparatus generates one or a plurality of Orthogonal Frequency Division Multiplexing (OFDM) symbols for channel estimation, each OFDM symbol including plural subcarriers and having a known signal sequence of known signals which are linearly independent between adjacent subcarriers; and transmits the OFDM symbols.

A wireless transmission apparatus generates one or a plurality of Orthogonal Frequency Division Multiplexing (OFDM) symbols for channel estimation, each OFDM symbol including plural subcarriers and having a known signal sequence of known signals which are linearly independent among a predetermined specific subcarrier of the plural subcarriers and subcarriers adjacent thereto; and transmits the OFDM symbols.

### BRIEF DESCRIPTION OF THE SEVERAL VIEWS OF THE DRAWING

FIG. 1 is a view showing an example of the subcarrier arrangement of a known signal for channel estimation according to the first embodiment;

FIG. 2 is a view showing an example of a frame format;

FIG. 3 is a block diagram showing an example of the arrangement of a wireless transmission apparatus;

FIG. 4 is a block diagram showing another example of the arrangement of the wireless transmission apparatus;

FIG. 5 is a view showing an example of the arrangement of a known signal for channel estimation;

FIG. 6 is a view showing another example of the arrangement of the known signal for channel estimation;

FIG. 7 is a view showing an example of the subcarrier arrangement of a known signal for channel estimation according to the second and third embodiments;

FIG. 8 is a view showing an example of the subcarrier arrangement of a known signal for channel estimation according to the fifth embodiment;

FIG. 9 is a view showing another example of the subcarrier arrangement of the known signal for channel estimation according to the fifth embodiment;

FIG. 10 is a view showing an example of the subcarrier arrangement of a known signal for channel estimation according to the sixth embodiment;

FIG. 11 is a view showing another example of the subcarrier arrangement of the known signal for channel estimation according to the sixth embodiment;

FIG. 12 is a view showing an example of the subcarrier arrangement of a known signal for channel estimation according to the seventh embodiment;

FIG. 13 is a view showing an example of the arrangement of a known signal for channel estimation according to the eighth embodiment;

FIG. 14 is a view showing another example of the arrangement of the known signal for channel estimation according to the eighth embodiment;

FIG. 15 is a view showing an example of the arrangement of a known signal for channel estimation according to the ninth embodiment;

FIG. 16 is a view showing another example of the arrangement of the known signal for channel estimation according to the ninth embodiment; and

FIG. 17 is a view showing still another example of the arrangement of the known signal for channel estimation according to the ninth embodiment.

### DETAILED DESCRIPTION OF THE INVENTION

### First Embodiment

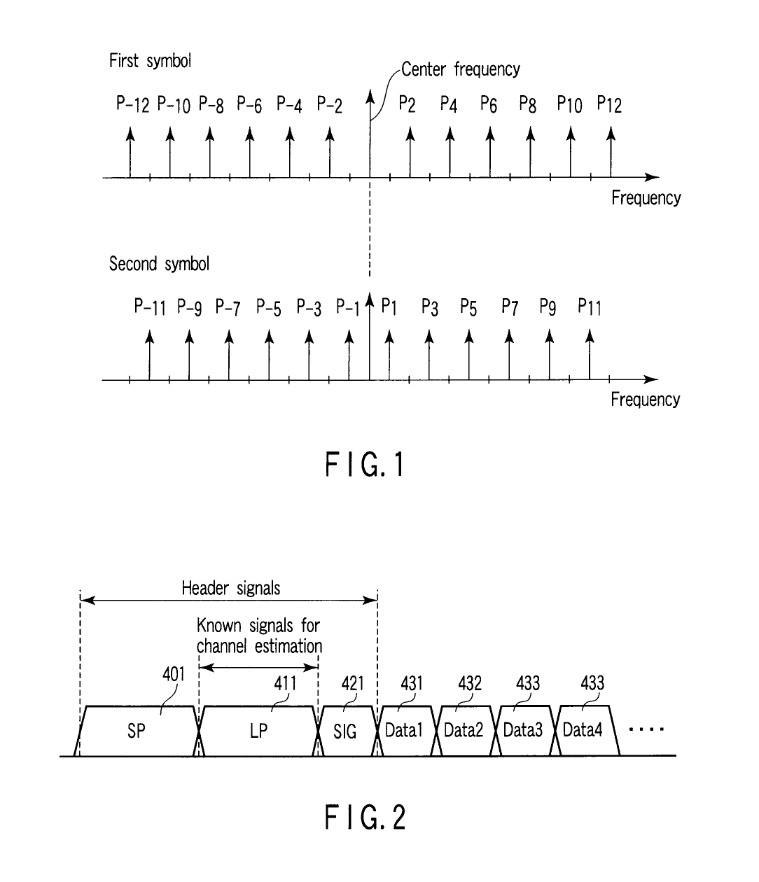

A wireless transmission method and wireless transmission apparatus according to the first embodiment will be described with reference to FIGS. 1 to 4.

Known signals for channel estimation according to the first embodiment are transmitted by two OFDM symbols. FIG. 1 shows the subcarriers included in the first symbol and the subcarriers included in the second symbol. As shown in FIG. 1, the first symbol is transmitted by using only even-numbered subcarriers, whereas the second symbol is transmitted by using only odd-numbered subcarriers.

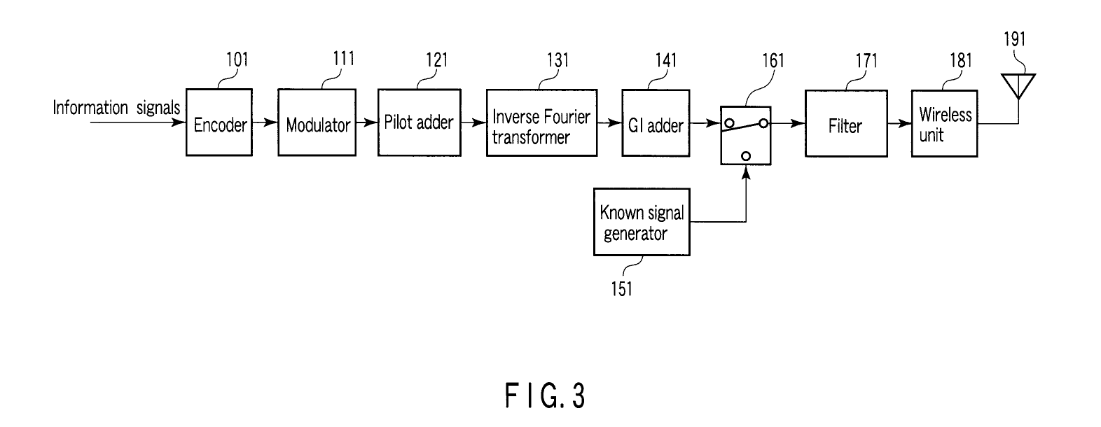

The wireless transmission apparatus in FIG. 3 includes an encoder 101, modulator 111, pilot adder 121, inverse Fourier transformer 131, guard interval (GI) adder 141, known signal generator 151, switch 161, filter 171, wireless unit 181, and transmission antenna 191.

The encoder 101 encodes a transmission signal. The modulator 111 modulates the encoded signal for each subcarrier. The pilot adder 121 adds a pilot signal for correcting a channel variation and/or phase error to each modulated signal in the frequency domain. The inverse Fourier transformer 131 then converts each signal into a signal in the time domain. The GI adder 141 adds a guard interval to each signal in the time domain to prevent intersymbol interference due to multipath delayed waves.

The known signal generator 151 stores the time-domain waveform of known signals for channel estimation, and outputs the waveform when transmitting the known signals. The switch 161 switches an input signal between the GI-added signal output from the GI adder 141 and the known signals output from the known signal generator 151 in accordance with a frame format. The filter 171 shapes the transmission signal output from the switch 161 into a desired frequency spectrum. The wireless unit 181 converts the shaped transmission signal from a digital signal to an analog signal, converts the signal into a radio-frequency signal, and transmits it from the transmission antenna 191.

The wireless transmission apparatus transmits a signal corresponding to a frame format in accordance with the format. FIG. 2 shows the frame format proposed in reference 2 as an example of the frame format. The known signals stored in the known signal generator 151 are sequentially output from the switch 161 to become known signals 401 and 411 in FIG. 2. In the case of known signal, a signal in the time domain which is obtained by applying inverse Fourier transform is also known in advance. If the known signal generator 151 (the memory which it has) stores the known signal after conversion into the signal in the time domain and the signal is read out from the memory, inverse Fourier transform processing can be omitted. This can prevent wasteful power consumption.

As shown in FIG. 1, a known signal comprises two symbols, and hence the known signal generator 151 of the wireless transmission apparatus stores two-symbol known signals for channel estimation.

Note that in the case of the subcarrier arrangement of the known signal for channel estimation shown in FIG. 1, the time waveforms of the first and second symbols are obtained by inverse Fourier transform as follows:

$$\begin{matrix}{Lp}_{1} ( m ) = {\sum }_{k = - N / 4}^{N / 4} {p}_{2 k} \cdot {e}^{j 2 π \frac{( 2 k ) m}{N}} & ( 1 ) \\ {Lp}_{2} ( m ) = {\sum }_{k = - N / 4}^{( N - 4 ) / 4} {p}_{2 k + 1} \cdot {e}^{j 2 π \frac{( 2 k + 1 ) m}{N}} & ( 2 )\end{matrix}$$

where N represents the total number of subcarriers including subcarriers which are not generally used, e.g., a center frequency and frequencies at the two ends of a band, pₖ is a known signal for channel estimation transmitted by the kth subcarrier, and Lₚ₁(m) and Lₚ₂(m) respectively represent the time waveforms of the first and second symbols of the known signal for channel estimation.

The known signal generator 151 stores Lₚ₁(m) and Lₚ₂(m) defined by m=0 to m=N−1 in advance and sequentially outputs them when transmitting a known signal for channel estimation.

Note that in general, in OFDM transmission, in order to prevent intersymbol interference caused by the influence of a multipath delayed wave, a signal is transmitted upon addition of several samples from the end of an effective symbol to the head of the signal. This keeps the periodicity of the signal, and hence can prevent intersymbol interference in the frequency domain. This signal is called a guard interval or cyclic prefix. The known signal generator 151 outputs a signal, including the addition of a guard interval, as follows:

gᵢ(m)=Lpᵢ((m+N−Ng)mod N) (3)

where Ng is the number of samples of the guard interval, gi(m) is a known signal for channel estimation of the ith symbol after addition of the guard interval, and mod represents remainder operation.

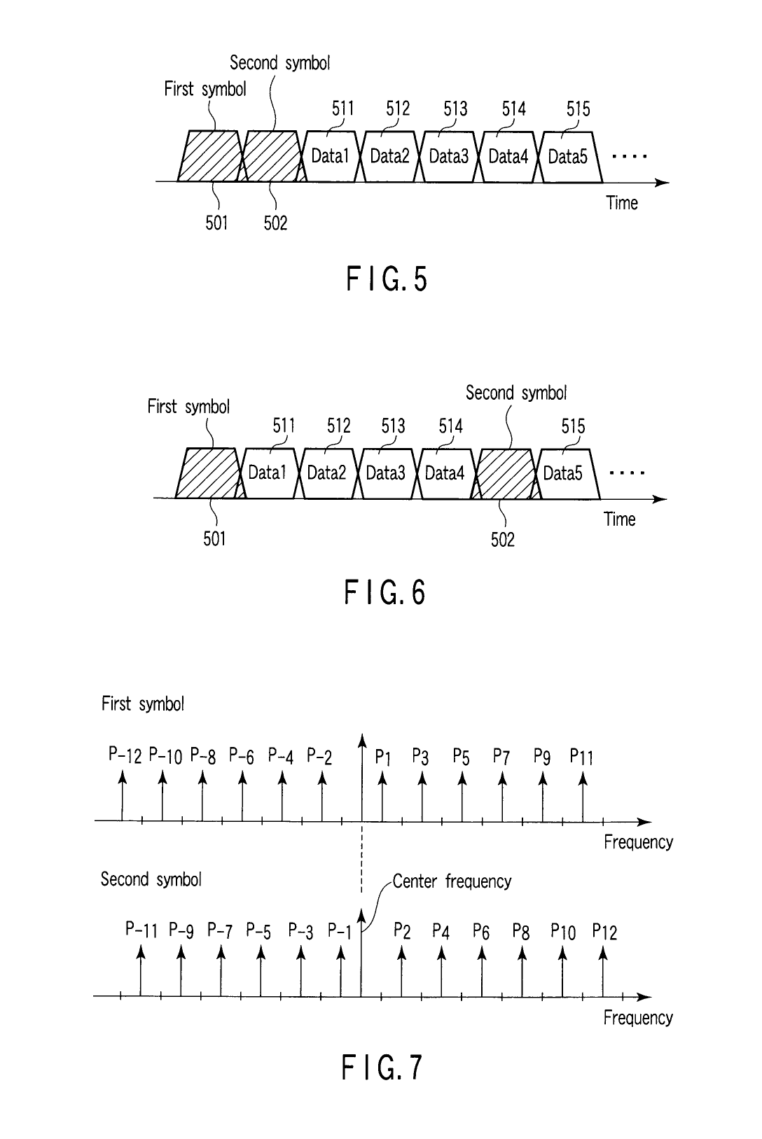

As shown in FIG. 2, the wireless transmission apparatus in FIG. 3 sequentially transmits the first and second symbols as known signals for channel estimation. At this time, as shown in FIG. 5, the apparatus may continuously transmit the first and second symbols. As shown in FIG. 6, the apparatus may transmit data symbols between the first and second symbols. Alternatively, the apparatus may transmit the second symbol first, and then transmit the first symbol. The apparatus may transmit signals in any order as known signals for channel estimation as long as signals which are not transmitted by adjacent subcarriers are transmitted, as shown in FIG. 1.

In the frame format shown in FIG. 2, a header signal 421 is a signal for notifying a reception unit of a modulation scheme, encoding ratio, and frame length applied to frame transmission, and changes in value depending on the arrangement of a frame to be transmitted. Data signals 431 to 433 differ for each OFDM symbol. When such signals are transmitted, the switch 161 is switched to the GI adder 141.

The transmitting operation of the wireless transmission apparatus in FIG. 3 will be described in detail next.

In general, an information signal is encoded by the encoder 101. However, the encoding scheme to be used is irrelevant to the gist of the present invention, and any scheme may be used. A generally used encoding scheme using a convolution code, Reed-Solomon code, turbo code, low-density parity check (LDPC) code, or the like may be used, or no encoding may be applied. In addition, interleaving may be applied after encoding, and the order of signals after encoding may be changed. Any technique may be used as long as it is a predetermined scheme, and the encoding scheme and the order of permutation are known to the wireless reception apparatus.

The modulator 111 receives the encoded signals output from the encoder 101. The modulator 111 divides the input signals to a plurality of subcarriers, and performs modulation for each subcarrier. In this case, the modulator 111 may divide input signals to a plurality of subcarriers in any order. That is, the modulator 111 may sequentially divide signals to subcarriers in descending or ascending order of frequency, or starting from frequencies near the center frequency. Any division order may be set as long as it is a predetermined order and known to the wireless reception apparatus which receives signals from the wireless transmission apparatus according to this embodiment.

Note that the modulator 111 may use any modulation scheme to be applied for each subcarrier. That is, the modulator 111 may use a phase modulation scheme such as binary phase shift keying (BPSK) or quadrature phase shift keying (QPSK), a quadrature amplitude modulation scheme such as 16 quadrature amplitude modulation (QAM) or 64 QAM, differential phase shift keying (DPSK), or the like. The modulator 111 may use any modulation scheme as long as it is a predetermined modulation scheme known to the wireless reception apparatus and allows demodulation. The modulator 111 may use the same modulation scheme for all the subcarriers or different modulation schemes for the respective subcarriers. Alternatively, different modulation schemes may be applied for the respective OFDM symbols. It suffices to use any modulation scheme as long as there is a means for notifying the wireless reception apparatus which one of modulation schemes has been used.

The pilot adder 121 will be described next. The pilot adder 121 transmits signals known to the wireless reception apparatus upon inserting it in a data symbol. This subcarriers will be referred to as pilot subcarriers. The pilot adder 121 adds signals to pilot subcarriers. In general, in OFDM transmission, in order to correct a local frequency shift, phase shift, or channel variation between the transmission apparatus and the reception apparatus, not all the subcarriers are used to transmit information, but some subcarriers are used to transmit signals known to the reception apparatus. The subcarriers of the known signals will be referred to as pilot subcarriers. The subcarriers for the transmission of information will be referred to as data subcarriers.

In this case, as an example of the arrangement of data subcarriers and pilot subcarriers, the arrangement disclosed in reference 2 uses four subcarriers, i.e., the −21st, −7th, 7th, and 21st subcarriers, as pilot subcarriers. The pilot adder 121 adds signals to these subcarriers.

Note that pilot subcarriers are irrelevant to the gist of the present invention, and any arrangement, any number of subcarriers, and any types of signals may be used. It suffices to use subcarriers with other numbers as long as they are predetermined numbers known to the wireless reception apparatus. Alternatively, no pilot subcarrier may be used.

The inverse Fourier transformer 131 converts a signal in the frequency domain into a signal in the time domain. At this time, the inverse Fourier transformer 131 may use either inverse fast Fourier transform (IFFT) or inverse discrete Fourier transform (IDFT) as a means for calculating an inverse Fourier transform. The inverse Fourier transformer 131 may use any type of means as long as it can convert a signal in the frequency domain into a signal in the time domain. A signal in the time domain may be cyclically delayed and output as long as the same delay is kept within one frame. Alternatively, the delay may be changed within a frame as long as it is known to the reception apparatus.

The GI adder 141 adds guard intervals to the signal converted into the time domain for each OFDM symbol. In this case, the number of samples of a guard interval and an adding scheme are irrelevant to the gist of the present invention, and the same scheme as that generally used in OFDM transmission is used. For this reason, a detailed description of this will be omitted.

As described above, the signal output from the known signal generator 151 or the signal generated by using the inverse Fourier transformer 131 is switched by the switch 161 in accordance with the frame format to be output to the filter 171. The filter 171 shapes the above signal into a desired frequency shape. In this case, the filter 171 is a generally used filter. This filter is irrelevant to the gist of the present invention, and hence a detailed description thereof will be omitted.

The wireless unit 181 converts the digital transmission signal generated in the above manner into an analog radio-frequency signal.

The wireless unit 181 is a general wireless unit comprising a digital-to-analog converter, filter, quadrature modulator, frequency converter, amplifier, and the like. Since this unit is irrelevant to the gist of the present invention, a detailed description thereof will be omitted.

The transmission signal converted into the radio-frequency signal by the wireless unit 181 is transmitted via the transmission antenna 191. In this case, as the transmission antenna 191, any type of antenna may be used as long as it can transmit a signal with a desired frequency.

The wireless transmission apparatus transmits signals in accordance with the above wireless transmission method.

Although the above description has exemplified the case in which signals are transmitted in accordance with the format in FIG. 2 as an example of a frame format, the frame format to be used in the present invention is not limited to that shown in FIG. 2. Any type of frame format may be used as long as the input destination of the switch 161 is switched to transmit a signal stored in the known signal generator 151 when transmitting known signals and to transmit an output from the GI adder 141 when transmitting information.

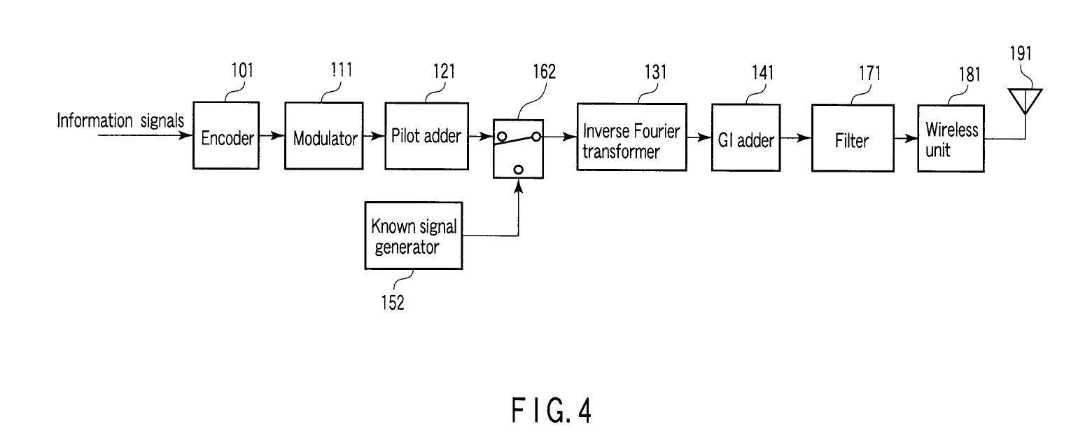

FIG. 3 has exemplified the case in which the known signal generator 151 in the wireless transmission apparatus stores the time-domain waveform of known signals for channel estimation. However, as shown in FIG. 4, a known signal generator 152 may store a signal in the frequency domain, and a switch 162 may operate to transmit either the data symbol to which a pilot is added by the pilot adder 121 or the known signals for channel estimation output from the known signal generator 152.

Note that if the signal sequences in the frequency domain transmitted by the first and second symbols of known signals for channel estimation are identical to each other, only the first symbol is stored in the known signal generator 152, and only the subcarriers arranged on the second symbol are changed. This reduces the amount of signals to be stored, and hence can reduce the memory size of the switch 162 and the circuit size. In addition, assume that the signal sequence of the second symbol in the frequency domain is that obtained by only inverting the signs of the sequence of the first symbol, or taking complex conjugates. In this case, only the first symbol is stored, and when the second symbol is to be transmitted, a signal can be generated by only inverting the signs of in-phase (channel) signals or quadrature-phase (channel) signals or the sings of both in-phase signals and quadrature-phase signals and changing the arrangement of the subcarriers.

If known signals for channel estimation are to be transmitted with the subcarrier arrangement shown in FIG. 1 in this manner, the wireless transmission apparatus may have the arrangement in FIG. 3 or FIG. 4.

A method of receiving signals transmitted by using the above wireless transmission method and the effects of the first embodiment will be described below.

The wireless reception apparatus which receives signals from the wireless transmission apparatus shown in FIG. 3 or 4 converts a received radio-frequency signal into a digital signal, converts the signal into a signal in the frequency domain for each OFDM symbol by Fourier transform, and generally performs demodulation processing for each subcarrier.

At this time, the reception signal of the kth subcarrier of the first OFDM symbol can be expressed by

rₖ(1)=hₖ(1)−sₖ(1)+nₖ(1) (4)

where sₖ(1) represents a modulated signal transmitted from the kth subcarrier of the first OFDM symbol, hₖ(1) represents the channel response of the kth subcarrier of the first OFDM symbol, and nₖ(1) represents noise added to the kth subcarrier.

As indicated by expression (4), amplitude distortion and phase distortion have occurred in the reception signal due to the influence of distortion caused by a multipath propagation path. If, however, the noise component nₖ(1) is white noise uncorrelated with the signal and channel response, estimating the channel response hₖ(1) makes it possible to perform demodulation by using a reception signal rₖ(1) and the estimated value of the channel response. In this case, demodulation indicates the execution of hard decision processing of estimating a transmitted symbol or soft output processing of obtaining the likelihood of a transmitted signal. This is irrelevant to the gist of the present invention and is a general demodulation scheme. Therefore, a detailed description of this will be omitted.

If a channel variation is small, estimating hₖ(1) by transmitting a known signal once makes it possible to apply demodulation by using the same estimation result for a plurality of OFDM symbols.

In this embodiment, the known signals for channel estimation shown in FIG. 1 are transmitted with the arrangement shown in FIG. 5 or 6. Channel estimation will be described below by exemplifying the case in which known signals for channel estimation are transmitted with the symbol arrangement in FIG. 5.

If the first symbol is transmitted as known signals for channel estimation, the reception signal represented by expression (4) can be expressed by

r₂ₖ(1)=h₂ₖ(1)·p₂ₖ+n₂ₖ(1) (5)

Since p₂ₖ in expression (5) is a signal known to the receiving side, a channel response h₂ₖ(1) can be easily estimated by dividing the reception signal by the known signal p₂ₖ. In this embodiment, since the first symbol of the known signals for channel estimation comprises only even-numbered subcarriers, the channel responses of the even-numbered subcarriers can be estimated from the reception signal.

On the other hand, the second symbol comprises only odd-numbered subcarriers, and hence the channel responses of the odd-numbered subcarriers can be estimated from the reception signal of the second symbol. In this manner, the channel responses of all the subcarriers used for communication can be obtained from the reception signal of the second symbol.

Note that as channel estimation schemes, there are available various schemes in addition to the above scheme, e.g., a scheme of reducing the influence of noise by weighting/combining using the channel response estimated values of a plurality of subcarriers, and a scheme of obtaining the channel response of each subcarrier by estimating an impulse response in the time domain by using the time waveform of known signals for channel estimation and converting the response into the frequency domain. Since these channel estimation schemes are irrelevant to the gist of the present invention, a detailed description thereof will be omitted.

As described above, if a reception signal is represented by expression (4) or (5), it is possible to demodulate a data signal by transmitting a known signal for channel estimation and causing the wireless reception terminal to estimate a channel response.

The wireless transmission apparatus converts a baseband signal into a radio-frequency signal and transmits it. The reception apparatus performs reception processing after converting the signal with the radio frequency into a baseband signal.

At this time, the transmission apparatus and the reception apparatus generate sine waves by using transmitters, respectively, it is difficult to generate accurate sine waves by using analog circuits. For this reason, a frequency offset occurs between the transmission apparatus and the reception apparatus or phase noise occurs in each transmitter. As a result, the orthogonality of each subcarrier in OFDM transmission deteriorates, and interference occurs between the signals of adjacent subcarriers. As a consequence, the demodulation accuracy deteriorates due to the influence of the inference between the subcarriers, resulting in deterioration in communication quality.

Since the above interference also occurs when known signals for channel estimation are transmitted, interference occurs from surrounding subcarriers as well as a noise component in expression (5). The channel estimation result also deteriorates. Since demodulation is performed from a reception signal including interference by using the channel estimation result whose accuracy has deteriorated, the demodulation is doubly affected by the interference, resulting in a noticeable deterioration.

On the other hand, according to the first and second symbols shown in FIG. 1, no adjacent subcarriers are transmitted. Of interference between subcarriers due to frequency offsets or phase noise, interference from adjacent subcarriers is the largest. Therefore, performing channel estimation by using known signals for channel estimation like that shown in FIG. 1 can reduce the influence of inter-subcarrier interference as compared with the prior art. This can therefore prevent signal demodulation from being doubly affected by interference, and hence can improve the demodulation accuracy.

As described above, the first embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission.

### Second Embodiment

A wireless transmission method and wireless transmission apparatus according to the second embodiment will be described.

The wireless transmission method of this embodiment is the same as that of the first embodiment in that it transmits known signals for channel estimation which comprises two OFDM symbols. The arrangement of the wireless transmission apparatus is the same as that of the wireless transmission apparatus shown in FIG. 3 or 4. This apparatus is also the same as that of the first embodiment in that known signal generators 151 and 152 each store two known signal sequences.

The second embodiment differs from the first embodiment in the subcarrier arrangement of known signals for channel estimation which is transmitted by the first and second symbols.

According to the first embodiment described above, interference occurs between subcarriers due to the influence of a frequency offset or phase noise, and interference from adjacent subcarriers is the largest. IQ imbalance is another type of analog circuit distortion which causes interference between subcarriers.

As described in the first embodiment, in a wireless unit 181, a digital-to-analog (D/A) converter converts an OFDM signal transmitted from the wireless transmission apparatus from a digital signal into an analog signal. The wireless unit 181 then converts the signal into a radio-frequency signal by quadrature modulation, and transmits it. Although it is ideal to keep constant the gains of an in-phase signal and quadrature-phase signal after quadrature modulation, it is difficult to realize this due to the imperfection of the analog circuit. The occurrence of an individual difference between the digital-to-analog (D/A) converter for an in-phase signal and the digital-to-analog converter for a quadrature-phase signal is equivalent to the addition of different gains to the in-phase signal and the quadrature-phase signal. When the quadrature modulator generates an in-phase signal and a quadrature-phase signal, it is ideal to accurately generate a phase difference of 90°. In practice, however, it is difficult to realize this. As a result, in outputs from the quadrature modulator, an in-phase signal and a quadrature-phase signal differ in amplitude, and the phase difference deviates from 90°.

On the other hand, the wireless reception apparatus multiplies a reception signal by two 90° out-of-phase sine waves by using the quadrature demodulator and the transmitter, and applies low-pass filters to the resultant signals, thereby obtaining an in-phase signal and a quadrature-phase signal. As in the wireless transmission apparatus, it is ideal to accurately generate a phase difference of 90°. In practice, however, it is difficult to generate such a phase difference. In general, owing to the gains of the filters and an individual difference between the analog-to-digital converters, the gains of an in-phase signal and quadrature-phase signal differ from each other.

The gain difference or phase error between an in-phase signal and a quadrature-phase signal which occurs in the wireless transmission apparatus and the wireless reception apparatus is called IQ imbalance, which causes a phenomenon in which signals interfere with each other between subcarriers symmetrical with respect to the center frequency in OFDM transmission. If, therefore, the influence of IQ imbalance is more dominant than a frequency offset or phase noise, interference between subcarriers at symmetrical positions with respect to the center frequency is more dominant than interference between adjacent subcarriers.

In the second embodiment, therefore, the subcarrier arrangement is set so as not to transmit known signals for channel estimation with adjacent subcarriers and with subcarriers symmetrical with respect to the center frequency, as shown in FIG. 7.

According to the first symbol of the known signals for channel estimation shown in FIG. 7, signals are transmitted from only even-numbered subcarriers lower in frequency than the center frequency, and signals are transmitted from only odd-numbered subcarriers higher in frequency than the center frequency. As a consequence, in the first symbol, no signals are transmitted with adjacent subcarriers and with subcarriers at symmetrical positions with respect to the center frequency. This can reduce inter-subcarrier interference contained in a channel estimation result even if IQ imbalance is added.

Likewise, in the second symbol, signals are transmitted from only odd-numbered subcarriers lower in frequency than the center frequency, and signals are transmitted from only even-numbered subcarriers higher in frequency than the center frequency, thereby obtaining the same effect as that in the case of the first symbol.

When the wireless transmission apparatus has the arrangement in FIG. 3, the known signal generator 151 stores the signal obtained by converting the known signals for channel estimation with the subcarrier arrangement shown in FIG. 7 into signals in the time domain. When the wireless transmission apparatus has the arrangement in FIG. 4, the known signal generator 152 stores the known signal for channels estimation with the subcarrier arrangement shown in FIG. 7 as the signal in the frequency domain without any change.

Other arrangements and processing operations are the same as those in the first embodiment, and a detailed description thereof will be omitted.

The receiving operation of the wireless reception apparatus which receives known signals like that shown in FIG. 7 is the same as that in the first embodiment except for the subcarrier arrangement of known signals for channel estimation, and hence a detailed description of the receiving operation will be omitted.

As described above, the second embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission.

In addition, even if interference occurs from subcarriers symmetrical with respect to the center frequency, the second embodiment can make the wireless reception apparatus implement high-accuracy channel estimation and use high-accuracy demodulation.

### Third Embodiment

A wireless transmission method and wireless transmission apparatus according to the third embodiment will be described.

The wireless transmission method of this embodiment is the same as that of the second embodiment in that it transmits two OFDM symbols having the subcarrier arrangement shown in FIG. 7 as known signals for channel estimation. The arrangement of the wireless transmission apparatus is the same as that shown in FIG. 3.

This embodiment differs from the second embodiment in a signal sequence transmitted by the first and second symbols of known signals for channel estimation.

In the second embodiment, as shown in FIG. 3, the known signal generator 151 stores the time-domain waveform of a signal. This obviates the necessity to calculate inverse Fourier transform when transmitting known signals for channel estimation and can reduce the power consumption and processing delay. However, the known signal generator 151 needs to store the first and second symbols as known signals for channel estimation, and hence needs to have a memory which stores two symbols.

This embodiment therefore proposes a signal sequence which allows to transmit the known signals for channel estimation shown in FIG. 7 by only causing the known signal generator 151 of the wireless transmission apparatus to store one symbol in the memory.

Giving consideration to the subcarrier arrangement of the known signals for channel estimation in FIG. 7 makes it obvious that the subcarrier arrangement of the second symbol is obtained by inverting the subcarrier arrangement of the first symbol about the center frequency.

Letting X(f) be a signal in the frequency domain and x(t) be a signal in the time domain which is obtained by performing inverse Fourier transform of the signal in the frequency domain, a signal obtained by inverting a complex conjugate signal of X(f) satisfies the inverse Fourier transform relationship represented by expression (6) given below:

X*(−f) [symbol] x*(t) (6)

Expression (6) represents that a complex conjugate signal of a signal in the frequency domain is inverted about the center frequency to be converted into a complex conjugate signal of the original signal in the time domain.

Using the above relationship, this embodiment transmits a signal satisfying expression (7) given below as a signal sequence of known signals for channel estimation.

p₋ₖ=pₖ* (7)

By transmitting a signal satisfying expression (7) using the subcarrier arrangement shown in FIG. 7, the second symbol is obtained by inverting a complex conjugate signal of the first symbol about the center frequency. Therefore, the time-domain waveforms of the first and second symbols represented by expressions (1) and (2) satisfy the relationship of expression (6), and hence satisfy the following expression:

Lp₂(m)=Lp₁*(m) (8)

It is obvious that the time-domain waveform of the second symbol is equivalent to a complex conjugate signal of the waveform of the first symbol. Therefore, the known signal generator 151 shown in FIG. 3 stores only the time-domain waveform of the first symbol of the first and second symbols, and outputs only a quadrature-phase channel signal upon inverting its phase when transmitting the second symbol.

In contrast, the same effect as that described above can be obtained by storing only the second symbol in the known signal generator 151 and outputting a quadrature-phase channel signal upon inverting its sign when transmitting the first symbol.

Alternatively, the same effect as that described above can be obtained by transmitting, as known signals for channel estimation, a signal obtained by inverting all the phases of the second symbol as represented by expression (9) given below.

p₋ₖ=−pₖ* (9)

As a consequence, the time-domain waveform of the second symbol satisfies expression (10):

Lp₂(m)=−Lp₁*(m) (10)

When a signal represented by expression (9) or (10) is to be transmitted as a known signal for channel estimation, the known signal generator 151 of the wireless transmission apparatus stores the time waveform of the first symbol, inverts the signs of only in-phase channel signals and outputs the resultant signals when transmitting the second symbol.

A specific example of the known signals for channel estimation represented by expression (7) or (9) is a signal sequence comprising real-number signals. In this case, the signal sequence indicated by expression (7) is written and expressed by expression (11) given below:

p₋ₖ=pₖ (11)

The signal sequence represented by expression (9) is written and expressed as expression (12):

p₋ₖ=−pₖ (12)

In this case as well, since the relationship represented by expression (8) or (10) holds, the known signal generator can transmit a signal by the same scheme as that described above.

In this manner, according to the wireless communication method, when transmitting a signal sequence satisfying expression (7) or (9) as known signals for channel estimation, the wireless transmission apparatus can generate a two-symbol known signals for channel estimation by simple computation by storing the time-domain signal of only one of the first and second symbols.

This embodiment has exemplified the case in which the wireless transmission apparatus in FIG. 3 is used. However, it is not always necessary to use the wireless transmission apparatus in FIG. 3. The above description applies to the wireless transmission apparatus shown in FIG. 4.

The wireless reception apparatus which receives one of signal sequences 1 to 3 described above as known signals for channel estimation performs the same receiving operation as in first and second embodiments regardless of the signal sequence of the known signals for channel estimation, and hence a detailed description of this operation will be omitted.

As described above, the third embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission.

In addition, even if interference occurs from subcarriers symmetrical with respect to the center frequency, the third embodiment can make the wireless reception apparatus implement high-accuracy channel estimation and use high-accuracy demodulation.

Furthermore, a wireless transmission apparatus can be provided, which can reduce the number of signals to be stored as known signals for channel estimation in the memory, and hence can reduce the circuit size and power consumption.

### Fourth Embodiment

A wireless transmission method and wireless transmission apparatus according to the fourth embodiment will be described.

The wireless transmission method of this embodiment is the same as that of first to third embodiments in that it transmits OFDM symbols with the subcarrier arrangement shown FIG. 1 or 7 as known signals for channel estimation. The arrangement of the wireless transmission apparatus is also the same as that shown in FIG. 3 or 4.

This embodiment differs from the first to third embodiments in that known signals for channel estimation comprises one OFDM symbol.

In the first to third embodiments, in order to prevent deterioration in channel estimation accuracy due to inter-subcarrier interference, two OFDM symbols are transmitted as known signals for channel estimation, as shown in FIG. 1 or 7. However, transmitting many known signals for channel estimation will degrade the transmission efficiency. For this reason, the wireless transmission method of this embodiment transmits only one of the first and second symbols shown in FIG. 1 or 7 as known signals for channel estimation. The known signal generator 151 or 152 in the wireless transmission apparatus stores one OFDM symbol. As in the first to third embodiments, when transmitting known signals for channel estimation in accordance with the frame format, the apparatus reads out the signal from the known signal generator and transmits it.

When only one symbol is to be used as known signals for channel estimation, interference from adjacent subcarriers and interference from subcarriers at symmetrical positions can be prevented as in the first to third embodiments.

Although deterioration in transmission efficiency can be prevented by transmitting one of the first and second symbols shown in FIG. 1 or 7 as an OFDM symbol which is known signal for channel estimation, the known signal for channel estimation is not transmitted from all the subcarriers. For this reason, the scheme described in the first embodiment cannot perform channel estimation for all the subcarriers.

In general, however, the channel responses of the respective subcarriers in OFDM transmission are not uncorrelated. For this reason, using the correlation between the subcarriers makes it possible to estimate the channel responses of not only the subcarriers by which a known signal for channel estimation has been transmitted but also the subcarriers by which the known signal for channel estimation has not been transmitted.

As an example of a channel estimation scheme using correlation, a scheme of performing interpolation between subcarriers is available. According to the scheme of performing interpolation, channel estimation for the subcarriers by which known signals for channel estimation has been transmitted is performed by the technique described in the first embodiment, and interpolation processing is performed by using the estimated channel responses to estimate the channel responses of the subcarriers by which the known signals for channel estimation has not been transmitted.

Consider a case in which the first symbol in FIG. 1 is transmitted as known signals for channel estimation. In this case, since the even-numbered subcarriers are used to transmit the known signals for channel estimation, channel estimation can be executed by the scheme described above. When linear interpolation is performed for the odd-numbered subcarriers in accordance with the channel response estimated values of the even-numbered subcarriers adjacent to them, the channel response of the (2k+1)th subcarrier can be estimated by using the channel estimated values of the 2kth and (2k+2)th subcarriers according to expression (13):

ĥ₂ₖ₊₁(1)=(ĥ₂ₖ(1)+ĥ₂ₖ₊₂(1))/2 (13)

By applying the above calculation, it is possible to estimate the channel responses of the odd-numbered subcarriers by which the known signals for channel estimation is not transmitted.

Another reception scheme is to estimate impulse responses in the time domain and obtain the channel responses of the respective subcarriers by Fourier transform of the estimated impulse responses. A known signal for channel estimation is a signal known to the wireless reception apparatus, and a signal in the time domain is known as well as a signal sequence in the frequency domain. Therefore, impulse responses are estimated by estimating the time-domain waveform of the known signal for channel estimation from the reception signal. In this case, impulse responses can be estimated by an estimation method based on the cross correlation between a reception signal and a known signal for channel estimation or can be estimated by the least squares method or the mean-square error minimum method.

In this manner, the channel responses of all subcarriers can be estimated by performing interpolation in the frequency domain or estimating impulse responses in the time domain without transmitting known signals for channel estimation by using all the subcarriers.

As a channel estimation method in the wireless reception apparatus, there are available, in addition to the above scheme, a scheme of separately interpolating the amplitudes and phases of channel responses when interpolation is performed in the frequency domain and a scheme of performing interpolation by using the channel responses of two or more subcarriers as well as adjacent subcarriers. It suffices to perform interpolation by using a function other than linear interpolation or weight/combine the channel responses of a plurality of subcarriers.

Various schemes other than the above impulse response estimation scheme are conceivable. However, the channel response estimation method to be used in the wireless reception apparatus is irrelevant to the gist of the present invention, and hence a detailed description thereof will be omitted.

As described above, the fourth embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission.

In addition, even if interference occurs from subcarriers symmetrical with respect to the center frequency, the fourth embodiment can make the wireless reception apparatus implement high-accuracy channel estimation and perform high-accuracy demodulation.

Furthermore, a wireless transmission apparatus can be provided, which can reduce the number of signals to be stored as known signals for channel estimation in the memory, and hence can reduce the circuit size and power consumption.

### Fifth Embodiment

A wireless transmission method and wireless transmission apparatus according to the fifth embodiment will be described.

This embodiment is the same as the first to fourth embodiments in that it transmits an OFDM system configured to prevent interference from adjacent subcarriers as known signals for channel estimation, and is the same as the second to fourth embodiments in that it transmits an OFDM symbol configured to prevent interference from subcarriers symmetrical with respect to the center frequency. The arrangement of the wireless transmission apparatus is the same as that shown in FIG. 3 or 4.

This embodiment differs from the first to fourth embodiments in that known signals for channel estimation is configured to suppress interference from not only two adjacent subcarriers and subcarriers at symmetrical positions with respect to the center frequency but also four or more adjacent subcarriers.

As described in the first embodiment, interference occurs from adjacent subcarriers due to the influence of a frequency offset between the wireless transmission apparatus and the wireless reception apparatus and phase noise produced in the respective apparatuses. At this time, interference occurs from not only two adjacent subcarriers but also all the subcarriers. Since interference power between two adjacent subcarriers is dominant, the effect of suppressing interference can be obtained by configuring known signals for channel estimation so as to thin out adjacent subcarriers as in the first to fourth embodiments. However, interference power increases with a decrease in distance to adjacent subcarriers as target subcarriers, inter-subcarrier interference can be further suppressed by configuring known signals for channel estimation so as to thin out nearby subcarriers as well as two adjacent subcarriers.

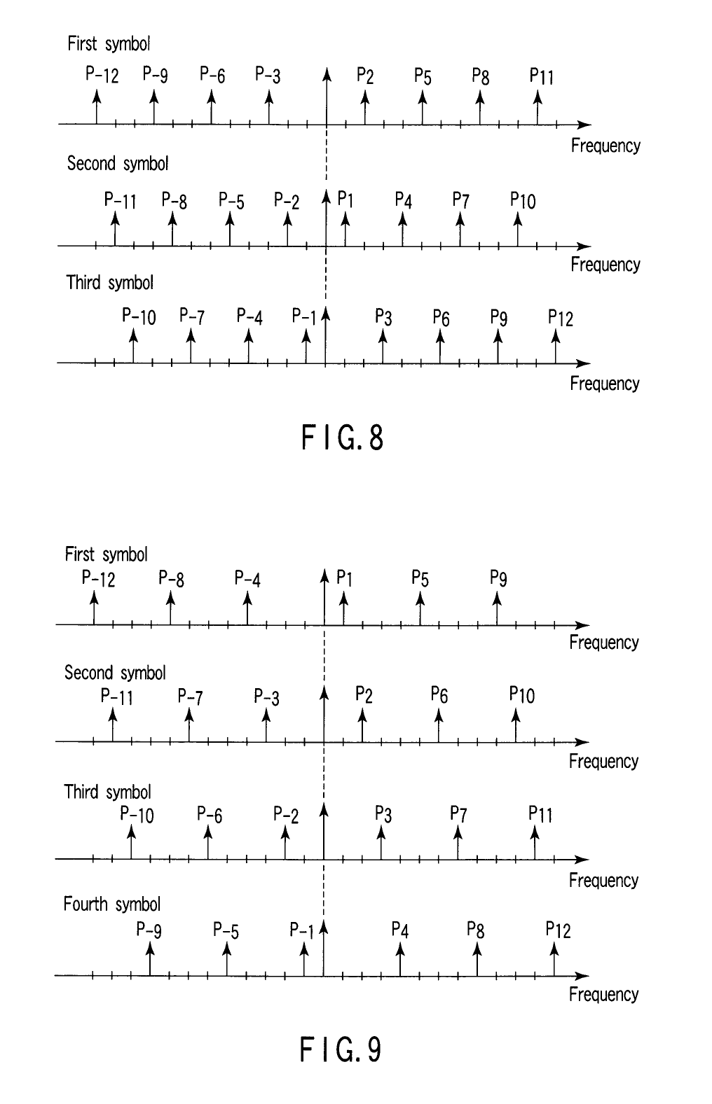

FIG. 8 shows an example of the subcarrier arrangement of known signals for channel estimation according to the fifth embodiment.

The known signals for channel estimation in FIG. 8 are included in three OFDM symbols. FIG. 8 shows the subcarriers transmitted by the first symbol, the subcarriers transmitted by the second symbol, and the subcarriers transmitted by the third symbol. In the case shown in FIG. 8, subcarriers are transmitted as known signals for channel estimation at intervals of three subcarriers to prevent interference from four adjacent subcarriers as well as two adjacent subcarriers.

In addition, since no signals are transmitted at subcarriers at symmetrical positions with respect to the center frequency of subcarriers to be transmitted as known signals for channel estimation, the same effect as that in the second embodiment can be obtained.

Configuring known signals for channel estimation in this manner can prevent interference from not only adjacent subcarriers and subcarriers at symmetrical positions with respect to the center frequency but also two higher subcarriers and two lower subcarriers.

The transmission apparatus is the same as that shown in FIG. 3 or 4. The known signal generator 151 or 152 stores the first, second, and third symbols in FIG. 8. As in the first to fourth embodiments, proper symbols are read out and transmitted in accordance with the frame format.

As shown in FIG. 9, the intervals of subcarriers which transmit known signals for channel estimation may be increased to four subcarriers.

The known signals for channel estimation in FIG. 9 comprises four OFDM symbols, i.e., the first, second, third, and fourth OFDM symbols. The subcarrier interval of each symbol which transmits known signals is four subcarriers. Each symbol is configured such that no signals are transmitted with subcarriers symmetrical with subcarriers which transmit known signals with respect to the center frequency.

Transmitting known signals for channel estimation with a subcarrier arrangement like that shown in FIG. 9 can prevent interference from three higher adjacent subcarriers and three lower adjacent subcarriers and interference from subcarriers at symmetrical positions with respect to the center frequency in the wireless reception apparatus.

It is obvious from the subcarrier arrangements shown in FIG. 9 that the subcarrier arrangements of the first and fourth symbols are symmetrical with respect the center frequency. Likewise, the subcarrier arrangements of the second and third symbols are symmetrical with respect to the center frequency.

If, therefore, all the signals transmitted by the first and fourth symbols are signal sequences satisfying expression (7) or (9), and all the signals transmitted by the second and third symbols are signal sequences satisfying expression (7) or (9), there is no need to store all four symbols in the memory in the known signal generator of the wireless transmission apparatus.

In this case, the wireless transmission apparatus shown in FIG. 3 may store the first (or fourth) symbol and the second (or third) symbol in a known signal generator 151.

An example of the transmission method to be used when the known signal generator 151 stores the first and second symbols, and the first and fourth symbols and the second and third symbols satisfy the relationship represented by expression (7) will be described.

The wireless transmission apparatus transmits the first to fourth symbols as known signals for channel estimation at a timing at which the signal should be transmitted in accordance with a frame format. When the first and second symbols are to be transmitted, the known signal generator 151 outputs the signals stored in the memory without any change. When the third symbol is to be transmitted, the signs of the quadrature-phase channels of the second symbol are inverted. When the fourth symbol is to be transmitted, the quadrature-phase channels of the first symbol are inverted.

Transmitting signals in this manner makes it possible to generate four symbols by storing only the waveforms of two of the four symbols in advance. If expression (9) is satisfied instead of expression (7), the same effect as that described above can be obtained by outputting the first and second symbols upon inverting the signs of in-phase channels of the symbols.

The case in which the known signal generator 151 stores only two of four symbols has been described. However, the present invention is not limited to this case. The known signal generator 151 may store only three of the four symbols or all four symbols.

The method of transmitting signal sequences satisfying expression (7) or (9) has been described as a wireless transmission method. If, however, the subcarrier arrangement in FIG. 9 is used as the subcarrier arrangement of known signals for channel estimation, the relationship between them need not always be satisfied.

The wireless reception apparatus which receives known signals for channel estimation with a subcarrier arrangement like that shown in FIG. 8 or 9 performs channel estimation by using the known signals for channel estimation as in the first to third embodiments.

As known signals for channel estimation according to this embodiment, the signals shown in FIGS. 8 and 9 have been described as examples. However, the present invention is not limited to this case.

The signals may be transmitted with subcarriers symmetrical with respect to the center frequency. Alternatively, the interval of subcarriers to be transmitted by one known symbol for channel estimation may be three or four or more subcarriers, and known signals for channel estimation may be included in three or four or more symbols.

In addition, as in the fourth embodiment, known signals for channel estimation may be included in only some of the symbols shown in FIG. 8 or 9, and the wireless reception apparatus may be made to perform interpolation processing.

As described above, the fifth embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission.

In addition, even if interference occurs from subcarriers symmetrical with respect to the center frequency, the fifth embodiment can make the wireless reception apparatus implement high-accuracy channel estimation and perform high-accuracy demodulation.

Furthermore, a wireless transmission apparatus can be provided, which can reduce the number of signals to be stored as known signals for channel estimation in the memory, and hence can reduce the circuit size and power consumption.

### Sixth Embodiment

A wireless transmission method and wireless transmission apparatus according to the sixth embodiment will be described.

This embodiment is the same as the first to fourth embodiments in that it transmits an OFDM symbol configured to prevent interference from adjacent subcarriers as known signals for channel estimation, and is the same as the second to fourth embodiments in that it transmits an OFDM symbol configured to prevent interference from subcarriers symmetrical with respect to the center frequency. The arrangement of the wireless transmission apparatus is the same as that shown in FIG. 3 or 4.

This embodiment differs from the first to fifth embodiments in that a known signal sequence for channel estimation is configured to mainly suppress interference to specific subcarriers instead of uniformly suppressing interference to all subcarriers.

When signals of the same type are to be transmitted by all subcarriers in OFDM transmission, the signals transmitted by the respective subcarriers are equal in level of importance, but all the subcarriers do not always transmit signals with the same level of importance. Some system may transmit a control signal and a notification signal by using specific subcarriers among all the subcarriers. In some case, it is more important to receive these signals correctly than to receive other subcarriers.

According to references 2 and 3, pilot signals are transmitted by specific subcarriers (referred to as pilot subcarriers hereinafter). The poor reception accuracy of pilot subcarriers may affect the reception of other subcarriers.

As described above, some systems need to receive specific subcarriers with higher accuracy than other subcarriers, and require higher accuracy for channel estimation.

In consideration of the above problems, therefore, this embodiment uses, as a wireless transmission method, a scheme of especially carefully protecting only specific subcarriers instead of uniformly protecting channel estimation for all the subcarriers against inter-subcarrier interference.

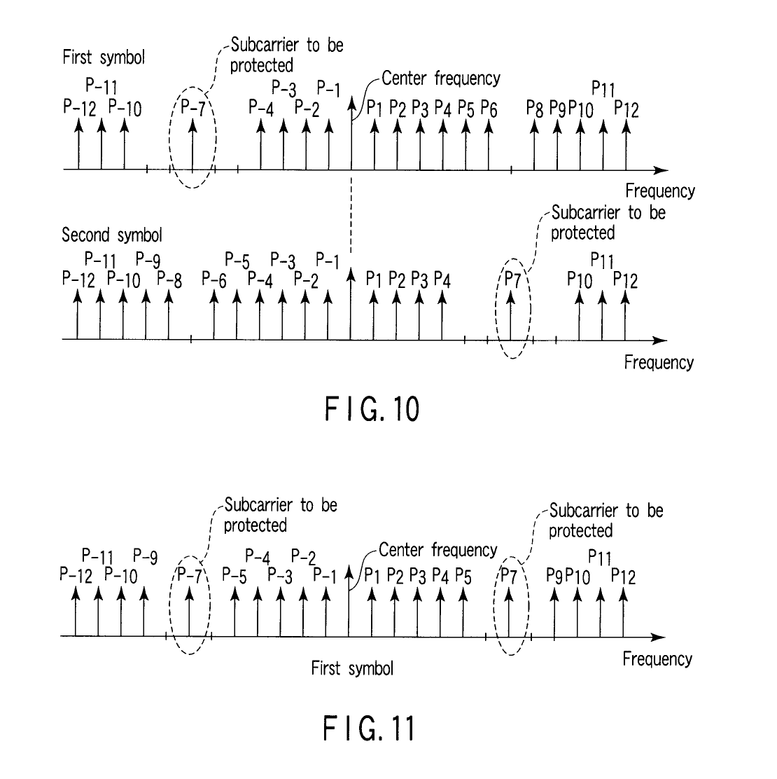

FIG. 10 shows an example of known signals for channel estimation in the wireless transmission method of the present invention. The known signals for channel estimation in FIG. 10 are included in the first and second symbols. FIG. 10 shows the arrangements of subcarriers transmitted by the first and second symbols, respectively.

In the case shown in FIG. 10, the +7th and −7th subcarriers are subcarriers to be protected. In the first symbol, no signals are transmitted by two higher subcarriers and two lower subcarriers than the −7th subcarrier (the −6th and −5th subcarriers higher in frequency than the −7th subcarrier, and the −8th and −9th subcarriers lower in frequency than the −7th subcarrier), and the +7th subcarrier at the position symmetrical to the −7th subcarrier with respect to the center frequency.

In the second symbol, a signal is transmitted by the +7th subcarrier, and no signals are transmitted by two higher subcarriers and two lower subcarriers than the +7th subcarrier (the +8th and +9th subcarriers higher in frequency than the +7th subcarrier, and the +6th and +5th subcarriers lower in frequency than the +7th subcarrier), and the −7th subcarrier.

Configuring a known signal sequence for channel estimation in this manner can prevent interference from two higher adjacent subcarriers and two lower adjacent subcarriers than each of the +7th and −7th subcarriers at the time of channel estimation in the wireless reception apparatus and interference from subcarriers at symmetrical positions with respect to the center frequency, thereby improving the accuracy of channel estimation.

As is obvious from FIG. 10, the first and second symbols have symmetrical subcarrier arrangements with respect to the center frequency. A wireless transmission apparatus is configured in the manner shown in FIG. 3 by configuring signal sequences transmitted by the first and second symbols so as to satisfy the following expression. This allows the wireless transmission apparatus to store only the time-domain waveform of the first (or second) symbol and allows the known signal generator 151 to output the second (or first) symbol, which is not stored in the memory, by only inverting only the signs of the quadrature-phase channel signals of the first symbol.

p₋ₖ(2)=pₖ*(1) (14)

where p₋ₖ(2) is a signal transmitted by the −kth subcarrier of the second symbol, and pₖ(1) is a signal transmitted by the kth subcarrier of the first symbol.

Likewise, if the first and second symbols satisfy the relationship represented by the following expression, outputting the signals stored in the memory upon inverting the signs of only the in-phase channels makes it possible to generate signals which are not stored in the memory.

p₋ₖ(2)=−pₖ*(1) (15)

This embodiment is the same as the first to fifth embodiments in that it transmits the known signal sequence for channel estimation described above in accordance with the frame format, and hence a detailed description thereof will be omitted.

On the other hand, channel estimation can be performed for the +7th and −7th subcarriers and two higher subcarriers and two lower subcarriers (±5, ±6, 8, and ±9) than each of the +7th and −7th subcarriers in the same manner as that described in the first embodiment. Channel estimation for other subcarriers can be performed in the manner represented by expression (16):

$${\hat{h}}_{k} = ( {r}_{k} ( 1 ) \cdot {p}_{k}^{*} ( 1 ) + {r}_{k} ( 2 ) \cdot {p}_{k}^{*} ( 2 ) ) / ( {\vert {p}_{k} ( 1 ) \vert}^{2} + {\vert {p}_{k} ( 2 ) \vert}^{2} ) \qquad ( 16 )$$

Note that the channel estimation scheme in the wireless reception apparatus is irrelevant to the present invention, and any technique other than that represented by expression (16) may be used.

The above embodiment has exemplified the wireless transmission method and the wireless transmission apparatus which transmit a signal with the subcarrier arrangement shown in FIG. 10 as known signals for channel estimation. However, the subcarrier arrangement to be used is not limited to that shown in FIG. 10.

The subcarrier arrangements of the first and second symbols may be set so as not to transmit any known signal by using an arbitrary number of subcarriers near a specific subcarrier to be protected. In addition, a subcarrier arrangement for the transmission of known signals may be one of those shown in FIGS. 1 and 7 to 9. In this case, a specific subcarrier can be protected, and the influence of inter-subcarrier interference can be suppressed. A symbol configured to transmit a signal by using a specific subcarrier to be protected may be configured so as not to transmit any signals by more subcarriers adjacent to the specific subcarrier.

If the number of symbols in which specific subcarriers to be protected transmit signals is smaller than that in which other subcarriers transmit signals, the transmission power of the specific subcarriers may be set to be higher than that of the other subcarriers.

In addition, it suffices to transmit a known signal sequence in a subcarrier arrangement configured so as to inhibit only subcarriers adjacent to specific subcarriers to be protected, as shown in FIG. 11, from transmitting any known signal for channel estimation, and to allow the wireless reception apparatus to apply interpolation processing to subcarriers by which the known signal has not been transmitted as in the fourth embodiment.

As described above, the sixth embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission.

Furthermore, a wireless transmission apparatus can be provided, which can reduce the number of signals to be stored as known signals for channel estimation in the memory, and hence can reduce the circuit size and power consumption.

### Seventh Embodiment

A wireless transmission method and wireless transmission apparatus according to the seventh embodiment will be described.

The arrangement of the wireless transmission apparatus in this embodiment is the same as that shown in FIG. 3 or 4 as in the fifth embodiment. This embodiment is also the same as the fifth embodiment in that known signals for channel estimation is configured to be robust against interference from not only two adjacent subcarriers but also other subcarriers at the time of channel estimation in the wireless reception apparatus.

This embodiment differs from the fifth embodiment in the subcarrier arrangement of known signals for channel estimation and the known signal sequence. That is, the embodiment differs from the fifth embodiment in that interference from a plurality of adjacent subcarriers as well as two adjacent subcarriers by inhibiting any signals from being transmitted from the adjacent subcarriers and assigning linearly independent sequences to the adjacent subcarriers used for the transmission of known signal sequence.

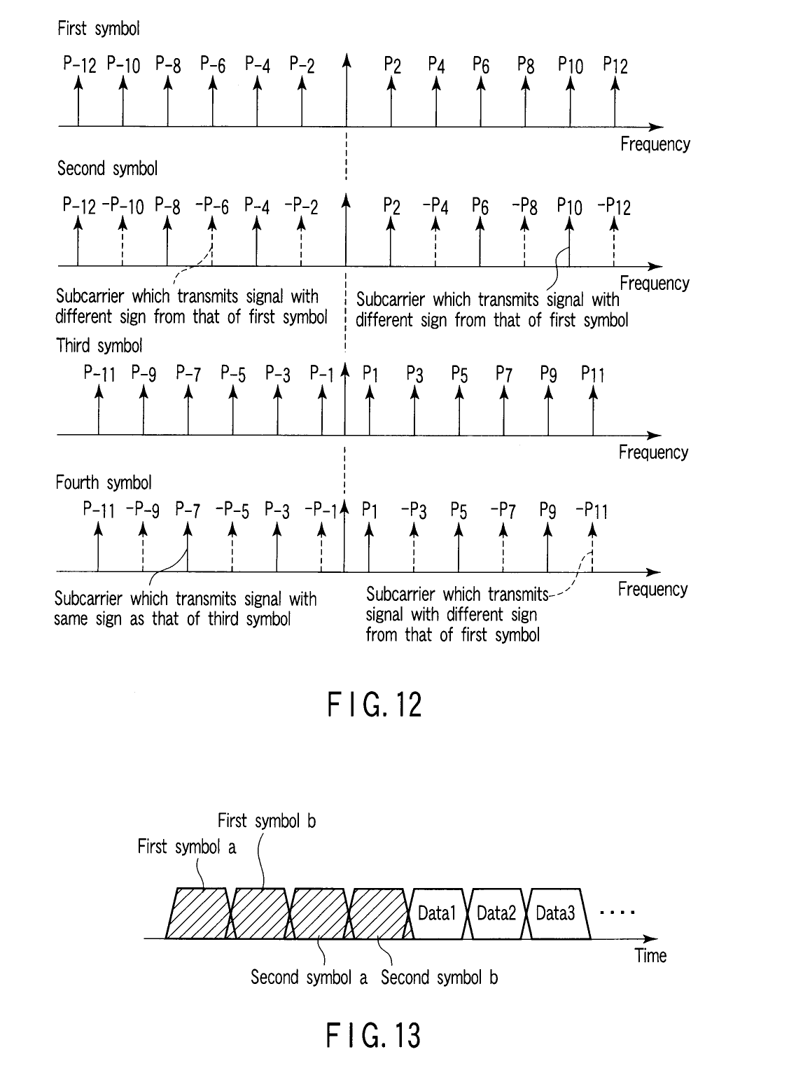

A scheme of assigning a orthogonal sequence comprising only +1 and −1 will be described in detail as a specific example of signal sequence with reference to FIG. 12.

Referring to FIG. 12, the subcarriers indicated by the solid lines are subcarriers which transmit identical signals in the first and second symbols, the subcarriers indicated by the dashed lines are subcarriers in the second symbol which transmit signals with signs different from those in the first symbol. In the case shown in FIG. 12, the −12th, −8th, −4th, +2nd, +6th, and +10th subcarriers in the first and second symbols transmit identical signals, and the −10th, −6th, −2nd, +4th, and +8th subcarriers in the first and second symbols transmit signals with different signs. The −11th, −7th, −3rd, +1st, +5th, and +9th subcarriers in the third and fourth symbols transmit identical signals, and the −9th, −5th, −1st, +3rd, +7th, and +11th subcarriers in the third and fourth symbol transmit signals with different signs.

The wireless transmission method of this embodiment transmits symbols having known signals of a known signal sequence for channel estimation like that shown in FIG. 12. Channel estimation in the wireless reception apparatus in a case in which such known signals for channel estimation is transmitted will be described next.

When performing channel estimation in subcarriers in the first and second symbols or the third and fourth symbols which transmit identical signals, the wireless reception apparatus performs in-phase addition of the reception signals of the first and second symbols and performs in-phase addition of the reception signals of the third and fourth symbols. This reduces the influence of noise. In addition, since interference from subcarriers spaced by two subcarriers is added in opposite phases, interference from the subcarrier spaced by two subcarriers can also be suppressed. Furthermore, signals transmitted by even-numbered subcarriers higher in frequency than the center frequency are added in opposite phases, and hence can be suppressed. As in the second and third embodiments, therefore, it is possible to suppress interference from three higher adjacent subcarriers and three lower adjacent subcarriers and interference from subcarriers symmetrical with respect to the center frequency, which are contained in a channel estimation result.

Likewise, with regard to subcarriers by which signals with different signs are transmitted in the first and second symbols or the third and fourth symbols, the difference between reception signals of the two symbols is obtained. As a result, interference from even-numbered subcarriers by which signals with the same sign are transmitted and interference from subcarriers at symmetrical positions with respect to the center frequency are added in opposite phases, thereby suppressing interference between the subcarriers which is contained in a channel estimation result.

A similar effect can be obtained with respect to subcarriers higher in frequency than the center frequency. Using orthogonal sequences can reduce the influence of inter-subcarrier interference contained in a channel estimation result as in the first to third embodiments.

Although a simple signal comprising +1 and −1 has been described as a orthogonal sequence for suppressing an interference signal, the present invention is not limited to this.

For example, with the subcarriers indicated by the solid lines in FIG. 12, transmission may be performed upon phase rotation through 90° in the second symbol, and with the subcarriers indicated by the dashed lines, transmission may be performed upon phase rotation through −90° in the second symbol.

In addition, as in the fifth embodiment, it suffices to determine subcarriers for the transmission of known signals for every three or four subcarriers by using three or more symbols of known signals for channel estimation.

As a orthogonal sequence, a Walsh-Hadamard code or a Fourier matrix is also available. This embodiment may use any type of orthogonal sequence. The embodiment may use any type of sequence as long as orthogonal sequences are assigned to adjacent subcarriers or orthogonal sequences are assigned to subcarriers symmetrical with respect to the center frequency.

In addition, orthogonal sequences may be applied to the subcarrier arrangement shown in FIG. 7 in the second or third embodiment.

Furthermore, in order to protect specific subcarriers, such as subcarriers for transmitting pilot signals, of a plurality of subcarriers contained in an OFDM symbol, it suffices to use a known signal sequence including known signals, which are transmitted by the specific subcarriers and subcarriers adjacent to the specific subcarriers, are orthogonal each other instead of inhibiting the transmission of known signals by using subcarriers adjacent to the specific subcarriers as shown in FIG. 10 or 11. In addition, it suffices to use a known signal sequence including a known signal transmitted by a subcarrier at positions symmetrical with the specific subcarriers with respect to the center frequency is orthogonal to a known signal transmitted by the specific subcarrier.

As described above, the seventh embodiment can make the wireless reception apparatus implement high-accuracy channel estimation without applying interference removal processing and use high-accuracy demodulation even in an environment in which interference occurs from adjacent subcarriers in OFDM transmission.

In addition, even if interference occurs from subcarriers symmetrical with respect to the center frequency, the wireless reception apparatus can implement high-accuracy channel estimation without applying interference removable processing, and can use high-accuracy demodulation.

### Eighth Embodiment

A wireless transmission method and wireless transmission apparatus according to the eighth embodiment will be described.

The wireless transmission method in this embodiment is the same as those in the first to seventh embodiments in that it transmits an OFDM symbol configured to prevent interference from adjacent subcarriers as known signals for channel estimation, and is the same as those in the second to seventh embodiments in that it is configured to prevent interference from subcarriers symmetrical with respect to the center frequency. The arrangement of the wireless transmission apparatus is the same as that shown in FIG. 3 or 4.

This embodiment differs from the first to seventh embodiments in that it transmits the same symbol as known signals for channel estimation a plurality of number of times.

As indicated by expression (4) or (5), since a reception signal generally contains noise, it is difficult to accurately perform channel estimation. For this reason, in this embodiment, the same symbol is transmitted a plurality of number of times, as shown in FIG. 13.

Referring to FIG. 13, a first symbol a is identical to a first symbol b, and a second symbol a is identical to a second symbol b. The influence of noise can be reduced by transmitting a plurality of known signals and performing in-phase addition of the first symbol a and the first symbol b and the second symbol a and the second symbol b when the reception apparatus performs channel estimation.

In addition, if a symbol having known signals for channel estimation has the subcarrier arrangement shown in FIG. 1 or 7, the same effects as those described above can be obtained by performing in-phase addition of a reception signal upon division by a known signal sequence when the reception apparatus performs channel estimation. Therefore, the first symbol a and the first symbol b may be different signal sequences.

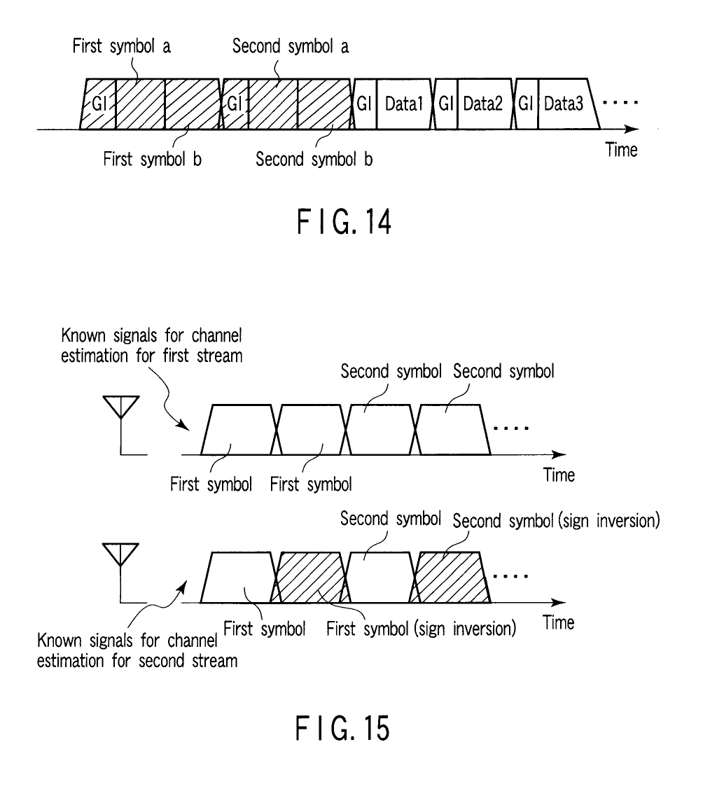

Furthermore, when the same symbol is to be transmitted a plurality of number of times, a guard interval may be added to only the head symbol, as shown in FIG. 14.

As described above, the eighth embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission.

In addition, even if interference occurs from subcarriers symmetrical with respect to the center frequency, the wireless reception apparatus can implement high-accuracy channel estimation, and can use high-accuracy demodulation.

Furthermore, when the reception apparatus performs channel estimation by transmitting a plurality of known signals with the same arrangement, in-phase addition can be performed, thereby improving the channel estimation accuracy.

### Ninth Embodiment

A wireless transmission method and wireless transmission apparatus according to the ninth embodiment will be described.

The wireless transmission method in this embodiment is the same as those in the first to fourth embodiments in that it transmits an OFDM symbol configured to prevent interference from adjacent subcarriers as known signals for channel estimation, and is the same as those in the second to fourth embodiments in that it is configured to prevent interference from subcarriers symmetrical with respect to the center frequency. The arrangement of the wireless transmission apparatus is the same as that shown in FIG. 3 or 4, and is the same as that in the first to fourth embodiments.

This embodiment differs from the first to fourth embodiments in that an OFDM signal is extended to Multiple Input Multiple Output (MIMO)-OFDM transmission in which signals are transmitted by using a plurality of transmission antennas.

The arrangement of known signals for channel estimation according to this embodiment will be described with reference to FIG. 15.

When a plurality of signals (referred to as streams in FIG. 15) are to be transmitted by MIMO transmission upon spatial multiplexing or different signals are to be transmitted in parallel from a plurality of antennas, it is necessary to estimate a channel response for each stream (or transmission antenna). In this case, as in OFDM transmission, a channel response can be estimated by transmitting a known signal for each stream. However, since a plurality of signals are simultaneously transmitted, it is impossible to estimate the channel responses of the respective streams (or transmission antennas) by using an arbitrary signal. In order to perform channel estimation in MIMO transmission, it is necessary to transmit signals of sequence linearly independent of each other as known signals for channel estimation from the respective streams. In general, orthogonal sequences are used as such signals.

When known signals for channel estimation is extended to MIMO transmission in this embodiment, letting pₖ(i) be a known signal for channel estimation to be transmitted by the kth subcarrier of the ith symbol, a known signal for channel estimation for each stream in the kth subcarrier can be expressed by

Sₖ=pₖ^{T} [symbol] Qₖ (17)

where [symbol] represents a Kronecker product, and T represents transposition. Sₖ represents a matrix having a known signal sequence for channel estimation for the mth stream at the kth subcarrier as the mth row vector, pₖ represents a vector having a known signal for channel estimation for the ith symbol as the ith element, and Qₖ represents a orthogonal sequence for MIMO transmission path estimation used by the kth subcarrier. In the case shown in FIG. 15, the number of streams is set to two, and the sequence represented by expression (18) given below is used as the orthogonal sequence Qₖ.

$${Q}_{k} = [ \begin{matrix}1 & 1 \\ 1 & - 1\end{matrix} ] \qquad ( 18 )$$

As a result, Sₖ is represented by expression (19).

$${S}_{k} = [ \begin{matrix}{p}_{k} ( 1 ) & {p}_{k} ( 1 ) & {p}_{k} ( 2 ) & {p}_{k} ( 2 ) \\ {p}_{k} ( 1 ) & - {p}_{k} ( 1 ) & {p}_{k} ( 2 ) & - {p}_{k} ( 2 )\end{matrix} ] \qquad ( 19 )$$

Consider further, for example, the fifth and sixth subcarriers when the symbols shown in FIG. 7 are to be used as the first and second symbols. In the case shown in FIG. 7, at the fifth subcarrier, no signal is transmitted by the second symbol. Likewise, at the sixth subcarrier, no signal is transmitted by the first symbol. Therefore, expression (19) can be expressed as follows:

$$\begin{matrix}{S}_{5} = [ \begin{matrix}{p}_{5} ( 1 ) & {p}_{5} ( 1 ) & 0 & 0 \\ {p}_{5} ( 1 ) & - {p}_{5} ( 1 ) & 0 & 0\end{matrix} ] & ( 20 ) \\ {S}_{6} = [ \begin{matrix}0 & 0 & {p}_{6} ( 2 ) & {p}_{6} ( 2 ) \\ 0 & 0 & {p}_{6} ( 2 ) & - {p}_{6} ( 2 )\end{matrix} ] & ( 21 )\end{matrix}$$

As described above, in the interval in which the first two symbols are transmitted, although a signal is transmitted by the fifth subcarrier, no signal is transmitted by the sixth subcarrier. This makes it possible to estimate a channel response without interference from adjacent subcarriers. Likewise, in the interval in which the third and fourth symbols are transmitted, since no signal is transmitted by the fifth subcarrier, it is possible to estimate a channel response at the sixth subcarrier by using the third and fourth symbols without any interference from adjacent subcarriers. Configuring known signal for channel estimation as indicated by expression (17) can suppress interference from adjacent subcarrier at the time of channel estimation even in MIMO-OFDM transmission.

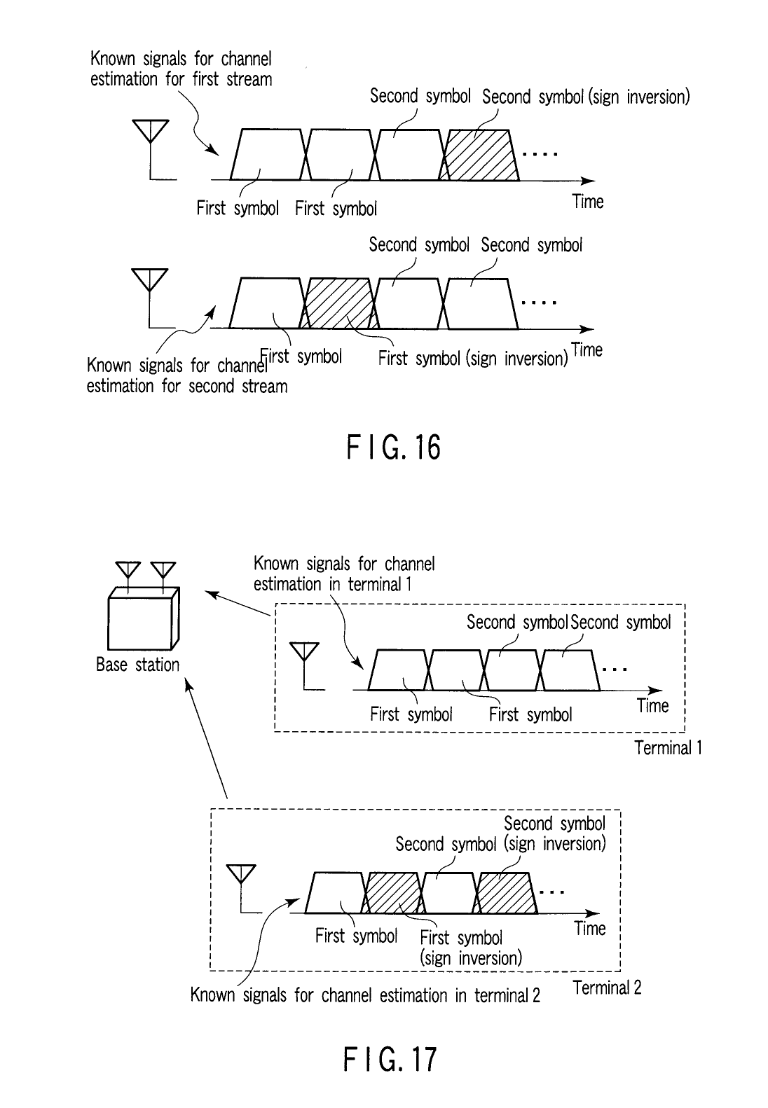

In the case shown in FIG. 15, identical orthogonal sequences are assigned to the first and second symbols. As shown in FIG. 16, it suffices to assign different orthogonal sequences to the first and second symbols. The case in which a simple sequence using only 1 and −1 is used as an orthogonal sequence has been described. However, as described in the seventh embodiment, another type of orthogonal sequence may be used, or a linearly independent sequence may be used instead of an orthogonal sequence.

The same effects as described above can also be obtained by using known signals for channel estimation in this embodiment as known signals for channel estimation in multi-user MIMO transmission in which a plurality of users simultaneously transmit signals as shown in FIG. 17 instead of MIMO transmission.

If a signal with the subcarrier arrangement shown in FIG. 7 is used as a known signal for channel estimation, interference from subcarriers at symmetrical positions with respect to the center frequency can also be suppressed as in the second embodiment. Setting a sequence to be assigned to each subcarrier in the same manner as in the third embodiment makes it possible to reduce the memory size of the transmission apparatus. Configuring subcarriers and signal sequences in the same manner as in the fifth or seventh embodiment can prevent interference from a plurality of adjacent subcarriers as well as two adjacent subcarriers and transmit a plurality of identical symbols in the same manner as in the eighth embodiment.

As described above, the ninth embodiment can suppress inter-subcarrier interference contained in a channel estimated value and allows the wireless reception apparatus to implement high-accuracy channel estimation and use high-accuracy demodulation even in an environment in which interference occurs from adjacent subcarriers in OFDM transmission and multi-user MIMO using OFDM signals.

In addition, even if interference occurs from subcarriers symmetrical with respect to the center frequency, the wireless reception apparatus can implement high-accuracy channel estimation, and can use high-accuracy demodulation.

Furthermore, when the reception apparatus performs channel estimation by transmitting a plurality of known signals with the same arrangement, in-phase addition can be performed, thereby improving the channel estimation accuracy.

As has been described above, according to the first to ninth embodiments, interference between subcarriers can be reduced, and high-accuracy channel estimation can be performed.

(1) The wireless transmission apparatus described above: generates one or a plurality of Orthogonal Frequency Division Multiplexing (OFDM) symbols for channel estimation, each OFDM symbol including plural subcarriers and having a known signal sequence of known signals which are linearly independent between adjacent subcarriers; and transmits the OFDM symbols.

According to the configuration, it is possible to suppress interference from adjacent subcarriers which is caused by a frequency offset or phase noise contained in a channel estimation result, and to improve demodulation accuracy.

The linearly independent known signal sequence means as follows:

(1a) Different subcarriers of the plural subcarriers are used to transmit the known signal sequence for the respective OFDM symbols, and subcarriers, of the plural subcarriers, which transmit the known signal sequence of each OFDM symbol are not adjacent to each other. This can prevent interference from adjacent subcarriers.

(1b) The subcarriers which transmit the known signal sequence of each OFDM symbol are at asymmetrical positions with respect to a center frequency of the plural subcarriers. This can prevent interference from subcarriers at symmetrical positions due to IQ imbalance.

(1c) The known signals included in the known signal sequence are orthogonal to each other between subcarriers at symmetrical positions with respect to a center frequency of the plural subcarriers. This can prevent interference from subcarriers at symmetrical positions due to IQ imbalance.

(1d) Subcarriers which transmit the known signal sequence of each OFDM symbol are at asymmetrical positions with respect to the center frequency of the plurality of subcarriers. And a complex conjugate signal of a known signal which is included in the known signal sequence of one of the OFDM symbols and is transmitted by one of two subcarriers at symmetrical positions with respect to the center frequency of the plural subcarriers is identical to a known signal which is included in the known signal sequence of another of the OFDM symbols and is transmitted by the other of the two subcarriers. This can reduce the memory area for storing known signals for channel estimation because it is only necessary to transmit a complex conjugate signal in the time domain.

(2) The wireless transmission apparatus described above: generates one or a plurality of Orthogonal Frequency Division Multiplexing (OFDM) symbols for channel estimation, each OFDM symbol including plural subcarriers and having a known signal sequence of known signals which are linearly independent among a predetermined specific subcarrier of the plural subcarriers and subcarriers adjacent thereto; and transmits the OFDM symbols.

(2a) Subcarriers, of the plural subcarriers, which transmit the known signal sequence are not adjacent to the specific subcarrier. This can prevent interference from subcarriers adjacent to the specific subcarrier by inhibiting the transmission of signals with subcarriers around the specific subcarriers.

(2b) A known signal included in the known signal sequence and transmitted with the specific subcarrier, and another known signal included in the known signal sequence and transmitted with a subcarrier adjacent to the specific subcarrier are orthogonal to each other. This prevents interference from subcarriers adjacent to the specific subcarriers by using orthogonal sequences.

(2c) The subcarriers, of the plural subcarriers, which transmit the known signal sequence are at a positions asymmetrical with the specific subcarrier with respect to a center frequency of the plural subcarriers, and are not adjacent to the specific subcarrier. This can prevent not only interference from adjacent subcarriers but also interference from subcarriers at symmetrical positions which is caused by IQ imbalance.

(2d) A known signal included in the known signal sequence and transmitted with the specific subcarrier and another known signal included in the known signal sequence and transmitted with a subcarrier adjacent to the specific subcarrier are orthogonal to each other. In addition, a known signal, which is included in the known signal sequence and is transmitted with a subcarrier at a position symmetrical with the specific subcarrier with respect to a center frequency of the plural subcarriers, is orthogonal to the known signal transmitted with the specific subcarrier. This can prevent not only interference from adjacent subcarriers but also interference from subcarriers at symmetrical positions which is caused by IQ imbalance.

What is claimed is:

1. A wireless transmission apparatus comprising:
a generating unit configured to generate one or a plurality of Orthogonal Frequency Division Multiplexing (OFDM) symbols for channel estimation, each OFDM symbol including plural subcarriers and having a known signal sequence of known signals which are linearly independent between adjacent subcarriers; and
a transmission unit configured to transmit the OFDM symbols.

2. The apparatus according to claim 1, wherein different subcarriers of the plural subcarriers are used to transmit the known signal sequence for the respective OFDM symbols, and subcarriers, of the plural subcarriers, which transmit the known signal sequence of each OFDM symbol are not adjacent to each other.

3. The apparatus according to claim 2, wherein the subcarriers which transmit the known signal sequence of each OFDM symbol are at asymmetrical positions with respect to a center frequency of the plural subcarriers.

4. The apparatus according to claim 2, wherein the known signals included in the known signal sequence are orthogonal to each other between subcarriers at symmetrical positions with respect to a center frequency of the plural subcarriers.

5. The apparatus according to claim 3, wherein a complex conjugate signal of a known signal which is included in the known signal sequence of one of the OFDM symbols and is transmitted with one of two subcarriers at symmetrical positions with respect to the center frequency of the plural subcarriers is identical to a known signal which is included in the known signal sequence of another of the OFDM symbols and is transmitted with the other of the two subcarriers.

6. The apparatus according to claim 2, wherein the subcarriers which transmit the known signal sequence are determined for every M subcarriers, M being a positive integer not less than one.

7. The apparatus according to claim 5, wherein the generating unit includes
a memory to store a time-domain signals of a first OFDM symbol of the OFDM symbols, and
a second symbol generating unit configured to generate a second OFDM symbol of the OFDM symbols by inverting at least one of an in-phase channel signal and a quadrature-phase channel signal of the time-domain signals stored in the memory.

8. A wireless transmission apparatus comprising:
a generating unit configured to generate one or a plurality of Orthogonal Frequency Division Multiplexing (OFDM) symbols for channel estimation, each OFDM symbol including plural subcarriers and having a known signal sequence of known signals which are linearly independent among a predetermined specific subcarrier of the plural subcarriers and subcarriers adjacent thereto; and
a transmission unit configured to transmit the OFDM symbols.

9. The apparatus according to claim 8, wherein subcarriers, of the plural subcarriers, which transmit the known signal sequence are not adjacent to the specific subcarrier.

10. The apparatus according to claim 8, wherein a known signal included in the known signal sequence and transmitted with the specific subcarrier, and another known signal included in the known signal sequence and transmitted with a subcarrier adjacent to the specific subcarrier are orthogonal to each other.

11. The apparatus according to claim 9, wherein the subcarriers which transmit the known signal sequence are located in asymmetrical positions with the specific subcarrier with respect to a center frequency of the plural subcarriers.

12. The apparatus according to claim 10, wherein a known signal, which is included in the known signal sequence and is transmitted by a subcarrier at a symmetrical position with the specific subcarrier with respect to a center frequency of the plural subcarriers, is orthogonal to the known signal which is transmitted with the specific subcarrier.

13. A wireless transmission method comprising:
generating one or a plurality of Orthogonal Frequency Division Multiplexing (OFDM) symbols for channel estimation, each OFDM symbol including plural subcarriers and having a known signal sequence of known signals which are linearly independent between adjacent subcarriers; and
transmitting the OFDM symbols.

14. The method according to claim 13, wherein different subcarriers of the plural subcarriers are used to transmit the known signal sequence for the respective OFDM symbols, and subcarriers, of the plural subcarriers, which transmit the known signal sequence of each OFDM symbol are not adjacent to each other.

15. The method according to claim 14, wherein the subcarriers which transmit the known signal sequence of each OFDM symbol are located in asymmetrical positions with respect to a center frequency of the plural subcarriers.

16. The method according to claim 14, wherein the known signals included in the known signal sequence are orthogonal to each other between subcarriers at symmetrical positions with respect to a center frequency of the plural subcarriers.

17. The apparatus according to claim 15, wherein a complex conjugate signal of a known signal which is included in the known signal sequence of one of the OFDM symbols and is transmitted with one of two subcarriers at symmetrical positions with respect to the center frequency of the plural subcarriers is identical to a known signal which is included in the known signal sequence of another of the OFDM symbols and is transmitted with the other of the two subcarriers.

18. The method according to claim 14, wherein the subcarriers which transmit the known signal sequence are determined for every M subcarriers, M being a positive integer not less than one.

19. A wireless transmission method comprising:
generating one or a plurality of Orthogonal Frequency Division Multiplexing (OFDM) symbols for channel estimation, each OFDM symbol including plural subcarriers and having a known signal sequence of known signals which are linearly independent among a predetermined specific subcarrier of the plural subcarriers and subcarriers adjacent thereto; and
transmitting the OFDM symbols.

20. The method according to claim 19, wherein subcarriers, of the plural subcarriers, which transmit the known signal sequence are not adjacent to the specific subcarrier.

21. The method according to claim 19, wherein a known signal included in the known signal sequence and transmitted with the specific subcarrier and another known signal included in the known signal sequence and transmitted with a subcarrier adjacent to the specific subcarrier are orthogonal to each other.

22. The method according to claim 20, wherein the subcarriers which transmit the known signal sequence are located in asymmetrical positions with the specific subcarrier with respect to a center frequency of the plural subcarriers.

23. The method according to claim 21, wherein a known signal, which is included in the known signal sequence and is transmitted with a subcarrier at a symmetrical position with the specific subcarrier with respect to a center frequency of the plural subcarriers, is orthogonal to the known signal which is transmitted with the specific subcarrier.
